(19) United States
(12) Patent Application Publication
(10) Pub. No.: US 2008/0082183 A1
(43) Pub. Date: Apr. 3, 2008

(54) BUILDING AUTOMATION SYSTEM WITH AUTOMATED COMPONENT SELECTION FOR MINIMUM ENERGY CONSUMPTION

(75) Inventor: John F. Judge, Galena, OH (US)

Correspondence Address: MCNEES WALLACE & NURICK LLC, 100 PINE STREET, P.O. BOX 1166, HARRISBURG, PA, 17108-1166, US

(73) Assignee: JOHNSON CONTROLS TECHNOLOGY COMPANY, Holland, MI (US)

(21) Appl. No.: 11/537,191

(22) Filed: Sep. 29, 2006

(51) Int. Cl. G05B 13/04

(52) U.S. Cl. 700/33; 700/28; 700/29; 700/32

(57) ABSTRACT

A software module for a building automation system includes a plurality of software modules. A first module is configured to compute energy consumption characteristics of a building. A second module is configured to determine at least one alternate hardware configuration for the building, and to provide an estimated performance level associated with each of the at least one alternate hardware configuration. A third module is configured to recommend one of the at least one hardware configurations based on at least one predetermined financial criteria.

### FIELD OF THE INVENTION

The present invention is directed to a building automation system (BASs), and more particularly to a building automation system with automated component selection for minimum energy consumption.

### BACKGROUND OF THE INVENTION

Currently there are building automation systems (BAS) used to provide central control, operation and data collection for commercial buildings having a variety of complex systems, e.g., HVAC, security, access control, fire protection, lighting and miscellaneous environmental systems. One such commercially available BAS is the ISN ConneXsys Control System manufactured by YORK, a Johnson Controls Company, of York, Pa., which utilizes a BACnet communication protocol. The BACnet protocol defines a number of services that are used to communicate between building devices. BACnet is a standard data communications protocol for building automation and control networks.

Such BASs perform various functions, including equipment scheduling, i.e., turning HVAC equipment off and on in response to BAS signals, optimization to start and stop HVAC equipment in anticipation of the occupancy load, operator adjustments, temperature monitoring, energy usage, equipment start times, operator logon, alarm reporting, and notification of equipment failure, out of limit conditions or maintenance, and many other relevant building parameters.

While flexible and versatile, BASs do not currently possess the capability to improve the performance of a building. In particular, BASs are not equipped to measure current energy consumption of a building on a component level, estimate the performance of alternative hardware options, and recommend new or reconfigured hardware arrangements based on financial metrics e.g., Return on Investment (ROI), payback period, etc., using known electricity rates and hardware costs.

Energy audits of commercial buildings are capable of being automated using existing BAS data. Most BASs capture sufficient data for accurately estimating the energy consumption of a particular building. The ability to combine automated energy audits with various financing arrangements in a software application, such as calculating initial payment, monthly payment, performance-based financing, etc., may be used to determine payback periods for capital equipment purchases for a building. As energy costs increase, energy consumption of buildings is an increasingly important factor in determining whether and when to invest in new hardware, rather than continue to operate obsolete and inefficient systems. The cost to purchase many HVAC components, e.g., variable speed drives (VSDs) and chillers, may in some cases be recaptured over a short payback period on the basis of the reduced energy consumption of the new hardware. Therefore, there is a need for a BAS that incorporates energy audit capability, BAS energy data, and integrated financial option calculation features.

### SUMMARY OF THE INVENTION

The present invention includes a method and a system for a BAS that provides recommendations for equipment configurations for buildings to improve operating costs related to energy consumption, efficiency and capital expenditures for equipment. The method may be embodied in a software module that is part of a BAS, or a standalone software implementation that extracts data from a BAS. The method performs three discrete functions in arriving at the building equipment recommendations. In the first step the method obtains the current energy consumption of the automated building based on measured or estimated energy usage. The second step is to estimate performance of various alternate equipment building equipment and configurations that differ from the existing equipment building equipment or configuration of the building. Finally, the system computes financial metrics based on actual or known utility rates and equipment costs, and makes one or more recommendations to reduce operational energy costs and/or improve operating performance in the building.

In one aspect, the present invention is directed to a software module for integration with building automation system (BAS). The software module has a plurality of subprograms. A first subprogram is configured to compute performance level characteristics of a building. A second subprogram is configured to determine at least one alternate building equipment configuration for the building, and an estimated performance level associated with the at least one alternate building equipment configuration. A third subprogram is configured to recommend one of the existing building equipment configuration or alternate building equipment configurations based on at least one predetermined financial criteria.

In another aspect, the present invention is directed to a computer program product. The computer program product is embodied on a computer readable medium and executable by a microprocessor for selecting components for minimum energy consumption in a building automation system. The computer program product includes computer instructions for executing the steps of computing energy consumption characteristics based on an existing building equipment configuration of a building; determining at least one alternate building equipment configuration for the building; providing an estimated performance level associated with the at least one alternate building equipment configuration; and recommending one of the existing building equipment configuration or the at least one alternate building equipment configurations based on at least one predetermined financial criteria associated with at least one of the performance level characteristics.

The present invention is also directed to a method of selecting components for minimum energy consumption in a building automation system. The method includes the steps of computing energy consumption characteristics of a building; determining at least one alternate building equipment configuration for the building; providing an estimated performance level associated with the at least one alternate building equipment configuration; and recommending one of the existing building equipment configuration or alternate building equipment configurations based on at least one predetermined financial criteria.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic diagram of an exemplary BAS network configuration.

FIG. 2 is a flow chart implementing the method of the present invention.

Wherever possible, the same reference numbers will be used throughout the drawings to refer to the same or like parts.

### DETAILED DESCRIPTION OF THE INVENTION

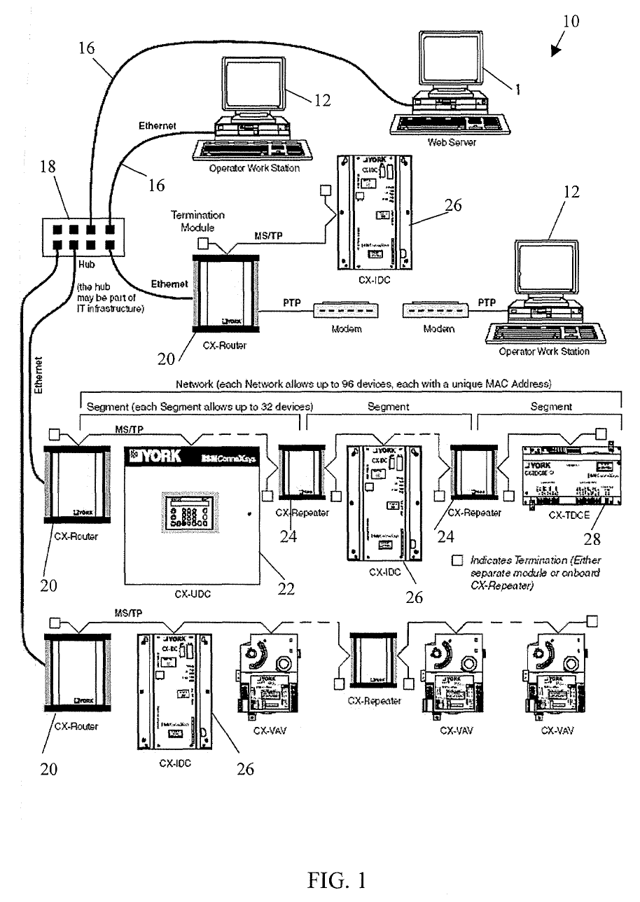

Referring to FIG. 1, a typical BAS network configuration is generally designated as 10. Various computer terminals such as operator workstations 12 and web servers 14 are examples of devices that may be interconnected with the BAS 10 as input/output (I/O) devices for operator and user communications. The computer terminals 12, 14 are connected via Ethernet or similar communication protocol cables, or via wireless communication link, 16 to a hub or hubs 18 to a plurality of data routers 20 that form the BAS network 10.

Data routers 20 are each connected to different network components, depending on the configuration of the particular building. For example, a direct digital controller (DDC) 22 for building management and control functions, such as the ConneXsys (CX-UDC) manufactured by YORK, a Johnson Controls Company (YORK), of York, Pa. The DDC 22 includes a network interface, and may be customized for HVAC or building control applications. The DDC 22 operates on a BACnet network protocol for connectivity with other devices and systems. The DDC 22 may be configured with various I/O modules for the appropriate type and number of I/O modules for the particular application—e.g., up to ten I/O modules (not shown) may be configured with up to 110 I/O points for various types of I/O control, including without limitation resistance, digital, pulse, 0 to 10 VDC, or 0-20 mA inputs and outputs. The DDC 22 may be configured to communicate with repeaters 24 for buffering digital and analog signals; microprocessor controllers 26 for air handling units (AHUs) and variable air volume (VAV) control centers, and other HVAC and building devices; and controllers for terminal unit applications 28. Some or all of these controller devices 22, 26, 28, may be configured to collect energy consumption data for systems that are they control. The BAS may include controls for operation of a chiller or refrigeration system.

The present invention is a software program or module for a BAS 10. Preferably, the software module is configured to provide recommendations for cost effective replacement hardware that may be implemented to reduce energy consumption in a building. The functionality is preferably segregated into three subprograms or stages, including current performance, potential performance, and hardware recommendations. While it is preferred that the BAS module be embodied in a computer program(s) and executed by a microprocessor, it is to be understood that the software module may be implemented and executed using digital and/or analog hardware by those skilled in the art. If hardware is used to execute the software module, the corresponding configuration of the BAS 10 can be changed to incorporate the necessary components and to remove any components that may no longer be required.

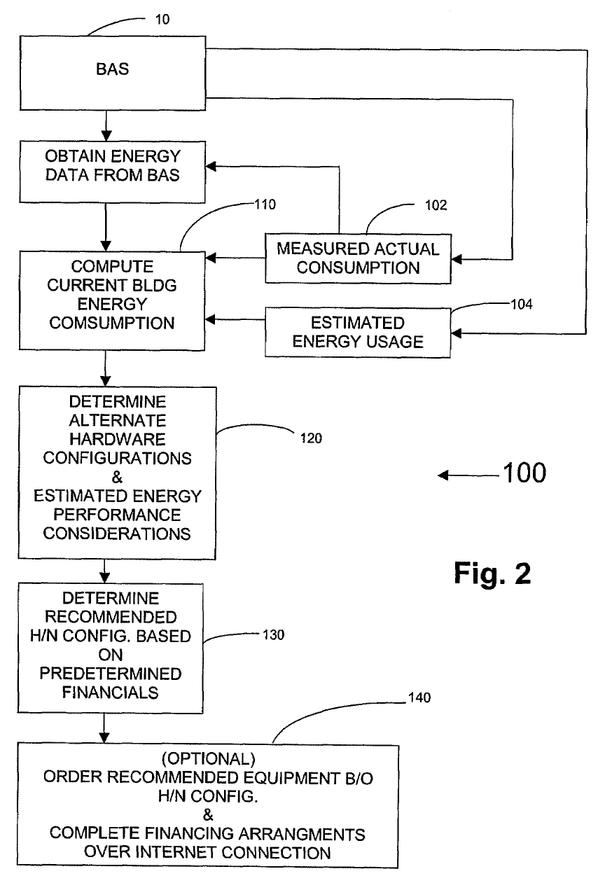

Referring to FIG. 2, a flow chart represents the method of the present invention, generally designated as 100. The method may be executed as a software program. The first stage 110 of the software module measures or estimates the current energy consumption of a building. Each energy-consuming component of the building system is included in the total estimate. Standard power measurement devices that connect to the BAS 10 provide the power consumption measurements 102, e.g., electric power meters, energy meters, voltage and current measuring devices, and the like. If power measurement devices are unavailable, or to eliminate the cost of installing additional energy measurement sensors, estimated energy usage 104, based on equipment rated load, power factor, diversity and efficiency, for example, may be used instead of actual energy measurements. The estimated energy usage 104 is computed based on empirical data, fundamental models, correlation algorithms, performance maps, and/or other methods. After the current building consumption is computed at step 110, the system proceeds to step 120 to determine alternate hardware configurations and estimated energy performance.

The second stage 120 of the software module is configured to estimate the performance of various alternative hardware options, given the building parameters, such as size, seasonal heating and cooling loads, occupancy, usage, climate and other energy profile information or characteristics associated with the building. Various hardware options may include variable speed drives (VSDs), new or different air handling units (AHUs), chiller systems, cooling towers, pumps, packaged rooftop units (RTUs) and other building system components. These performance estimates may be based on empirical data, fundamental models, correlations, performance maps, and/or other methods. The hardware options are based on accepted practices and general knowledge in the HVAC industry, and permit a building owner or designer to consider alternative hardware configurations, e.g., due to changes in utility costs, increased capital spending, or information that was unavailable at the time that the building was constructed. Preferably, a comprehensive database of hardware options is compiled for all buildings and updated along with the BAS, via the Internet.

In one embodiment of the performance estimating software module, the user inputs data regarding the size and type of building or facility for the HVAC system. Based on those user inputs, the performance-estimating module generates recommended equipment types and sizes suitable for the building or facility and any other restrictions that the user may have. Other restrictions can include costs, the ambient weather and climate of the area where the building is located, and the relative load that the HVAC system will encounter with the building or facility, to name a few.

The software program may include a database of HVAC equipment components, which are all compatible and capable of forming a working HVAC system. In addition to the user inputs based on the building or facility types, the performance-estimating module applies building type inputs selected from predetermined ASHRAE building types. For a more efficient use of the ASHRAE building types, the performance-estimating module allows the user to divide the entire building or facility into different ASHRAE building types, if necessary. The division of the building into subparts allows for a more accurately designed HVAC system that can account for different loads and specifications of individualized areas within the larger building or facility.

As an example, in a hospital facility, patient rooms carry more load with people and medical equipment than would a supply room. The user may classify the patient rooms as one subpart, the supply rooms as a second subpart, and so on, with each different subpart classifying as a different ASHRAE building type. The division into subparts corresponding to multiple ASHRAE building types permits the user to compensate for the differences in load distribution and HVAC requirements in those different areas when designing an HVAC system.

In addition to dividing the building or facility into different ASHRAE building types, the performance-estimating module may include various weather and climate conditions for different geographical areas and different seasonal conditions to assist in more accurate and realistic load burdens on the proposed HVAC system. The various weather and climate conditions may be present in a database associated with the system, or accessible through internet connections to linked data sources. The user has the ability to identify the geographical location of the proposed building and the program includes the outdoor ambient temperature and climate into the calculations for the proposed load on the system. The present invention thus presents an opportunity for the user to have equipment intelligently chosen based on input parameters such as building size and type.

After determining one or more alternate HVAC/energy hardware configurations in step 120, the program then proceeds to the third software module at step 130. The third software module 130 is configured to determine hardware recommendations. Hardware recommendations are based on predetermined financial criteria, such as return on investment (ROI), payback period, etc. The financial criteria are computed based on established electricity rates and hardware costs. Alternately, predictions of anticipated future electricity rate increases and hardware costs may be considered in computing the financial criteria. The third software module 130 provides recommendations based on the financial criteria, and preferably, includes an error factor to account for uncertainty in the performance estimates. The user has the ability to review and to override specific options, may select the order of importance of the various financial parameters, and may select a configuration that is different from recommended one. The software provides the recommendations ranked in order based on the predetermined criteria.

The software program 100 may include a fourth software module 140. The fourth software module 140 includes a communication link to access an Internet connection between the hardware equipment supplier—upon whose equipment the hardware recommendations are based—and the BAS end-user or building owner/operator. If an Internet connection is available, the fourth module 140 provides the capability of ordering components of the recommended hardware configuration and of making financing arrangements via the suppliers website or other secure communication link, at step 140. Depending on the preferences established by the end-user, a greater or lesser degree of Internet connectivity may be employed. The hardware supplier may provide the end-user with prices instantly on various building systems products such as hardware, updates to existing performance modules, updated component lists, recent financing rates, and similar components, via the Internet connection established by the fourth module 140 communication link between the end-user and the supplier. The fourth software module 140 may also include the capacity for the end-user to schedule a service technician of the hardware supplier for installing a new component (e.g., an AHU or VSD), and to obtain financing through the hardware supplier at the same time. Preferably, the end-user may place such orders by clicking a button on a local network operator terminal, or on the hardware supplier website.

It should be noted that, while the invention is described in terms of various software modules having predetermined, discrete functionality, these various functions may be provided in alternate embodiments in one or another of the software modules, within the scope of the present invention.

Most of the above functionality may be achieved for other building performance factors such as acoustic or indoor air quality (IAQ), rather than for energy performance. Hardware recommendations for acoustic performance or IAQ may be based on a prioritization of the cost effectiveness of various design parameters, such as cost per dBa for acoustic performance criteria, or cost per unit of CO₂ for IAQ standards, as opposed to justifying the purchase on purely financial grounds (e.g., payback period) as set forth above.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A performance analysis module for a building automation system used to control a building comprising:
a first system configured to compute a plurality of performance level characteristics based on an existing building equipment configuration of a building;
a second system configured to determine at least one alternate building equipment configuration for the building, and an estimated performance level characteristic associated with the at least one alternate building equipment configuration; and
a third system configured to recommend one of the existing building equipment configuration or the at least one alternate building equipment configurations based on at least one predetermined financial criteria associated with at least one of the plurality of performance level characteristics.

2. The module of claim 1, also comprising a fourth system configured to order building equipment from a predetermined supplier based upon the recommended existing or alternate building equipment configuration.

3. The module of claim 2, wherein the fourth system is also configured to arrange financing through the supplier.

4. The module of claim 3, wherein the fourth system is also configured to schedule a service technician of the supplier to install newly ordered building equipment.

5. The module of claim 1, wherein the first system computes the plurality of performance level characteristics based on at least one actual energy consumption measurement associated with the building.

6. The module of claim 5, wherein the at least one actual energy consumption measurement associated with the building is derived from at least one standard power measurement device.

7. The module of claim 6, wherein the at least one standard power measurement device is selected from the group consisting of electric power meters, energy meters, voltage and current measuring devices, and combinations thereof.

8. The module of claim 1, wherein the first system includes performance level characteristics based on at least one estimated energy consumption parameter associated with the building.

9. The module of claim 8, wherein the at least one estimated energy consumption parameter is based on one of empirical data, fundamental models, correlations, performance maps, and combinations thereof.

10. The module of claim 1, wherein the second system determines the at least one alternate building equipment configuration for the building, and the estimated performance level is based on a plurality of building parameters.

11. The module of claim 10, wherein the building parameters include at least one selected from the group consisting of building size, seasonal heating and cooling loads, occupancy, usage, climate and energy profile characteristics associated with the building.

12. The module of claim 10, wherein the at least one alternate building equipment configuration comprises at least one selected from the group consisting of variable speed drives, an air handling unit, a chiller system, cooling towers, pumps, packaged rooftop units and combinations thereof.

13. The module of claim 10, wherein the estimated performance level is computed based on one or more of empirical data, fundamental models, correlations, or performance maps.

14. The module of claim 10, wherein the second system includes a database of HVAC equipment components, the HVAC equipment components being inter-compatible and capable of forming a working HVAC system.

15. The module of claim 10, wherein the second system applies at least one building type input selected from a plurality of predetermined building types.

16. The module of claim 10, wherein the second system is configured to divide the building into a plurality of building types to account for varying loads within the building.

17. The module of claim 1, wherein the building performance characteristics also include an acoustic performance factor or an indoor air quality (IAQ) factor, and building equipment recommendations for acoustic performance or IAQ are based on a cost per dBa relative to the acoustic performance factor, or on a cost per unit of CO2 for the IAQ factor.

18. A computer program product embodied on a computer readable medium and executable by a microprocessor for selecting building equipment components for minimum energy consumption in a building automation system, the computer program product comprising computer instructions for executing the steps of:
computing energy consumption characteristics based on an existing building equipment configuration of a building;
determining at least one alternate building equipment configuration for the building;
providing an estimated performance level associated with the at least one alternate building equipment configuration; and
recommending one of the existing building equipment configuration or the at least one alternate building equipment configurations based on at least one predetermined financial criteria.

19. The computer program product of claim 18, further comprising computer instructions for executing the steps of:
accessing an Internet connection between a building equipment equipment supplier and a BAS end-user
based on the recommended building equipment configuration, providing the BAS end-user with prices on building equipment products in the recommended building equipment configuration via the Internet connection.

20. The computer program product of claim 19, further comprising computer instructions for executing the steps of:
scheduling a service technician of the building equipment supplier for installing a building equipment product; and
obtaining financing through the building equipment supplier.

21. A method of selecting building equipment components for minimum energy consumption in a building automation system, comprising computing energy consumption characteristics based on an existing building equipment configuration of a building;
determining at least one alternate building equipment configuration for the building;
providing an estimated performance level associated with the at least one alternate building equipment configuration; and
recommending one of the existing building equipment configuration or the at least one alternate building equipment configurations based on at least one predetermined financial criteria.

22. The method of claim 21, also including the steps of:
accessing an Internet connection between a building equipment equipment supplier and a BAS end-user based on the recommended building equipment configuration, providing the BAS end-user with prices on building equipment products in the recommended building equipment configuration via the Internet connection.

23. The method of claim 22, also including the steps of:
scheduling a service technician of the building equipment supplier for installing a building equipment product; and
obtaining financing through the building equipment supplier.
